(19) United States
(12) Patent Application Publication
(10) Pub. No.: US 2002/0149904 A1
(43) Pub. Date: Oct. 17, 2002

(54) Gas-insulated switch

(76) Inventors: Masaki Hachida, Hitachi (JP); Hirohiko Yatsuzuka, Hitachi (JP); Kenji Annou, Hitachi (JP); Tadasuke Yamamoto, Hitachi (JP)

Correspondence Address: MATTINGLY, STANGER & MALUR, P.C., 1800 DIAGONAL ROAD, SUITE 370, ALEXANDRIA, VA, 22314, US

(21) Appl. No.: 10/069,016

(22) PCT Filed: Feb. 23, 2001
(86) PCT No.: PCT/JP01/01393

(30) Foreign Application Priority Data
Mar. 13, 2000 (JP) 2000-73903

(51) Int. Cl. H02B 7/00

(52) U.S. Cl. 361/605; 361/620

(57) ABSTRACT

Bushing leader circuits 3, 4 are connected to end portions of two main buses 1, 2 on the side of a leading-in steel tower 110, and cable head units 85, 95 of cable leader circuits 6, 7 connected to the main buses 1, 2 are arranged in a space formed between the main buses 1 and 2. Thereby it is possible to achive both of simplification of a cable channel and the economy of the apparatus.

### TECHNICAL FIELD OF THE INVENTION

The present invention relates to a gas-insulated switchgear installed in an electric station such as a transformer station, a switching station.

### BACKGROUND OF THE ART

In a transformer station or the like, high voltage power is taken in from the outside of the station or the high voltage power is supplied to the outside. Further, high votage power from not only one overhead line but also a plurality of overhead lines is treated. Therefore, using a gas-insulated switchgear, the high voltage power from a plurality of overhead lines is collected into a bus or buses to be treated and when the falling of a thunderbolt or the like occurred, the station is separated from the lines.

The high voltage power from a plurality of overhead lines, first of all, is received by bushings each made of highly insulating material. Insulation between the bushings is effected by air, so that they are arranged at a sufficient distance from one another. The high voltage power received by the bushings is led to the main buses through lead-in lines, and two buses are taken because of redundant system, however, since a long distance is taken between the bushings, it is conneced to the two main buses from the outside.

### DISCLOSURE OF THE INVENTION

In the case where the buses are arranged perpendicularly to a row of bushings, it is considered to provide circuit breakers between bushing leader lines and the buses. In such a case, generally, it is designed so as to be narrow between the bases. In this manner, bushing connecting circuits are connected to a bus sectionalizing circuit, however, when a distance between the bases is set small, for example, a circuit breaker of the bushing connecting circuit is arranged out of the buses, whereby a site area for the gas-insulated switchgear has been large.

Further, in such a conventional technique as disclosed in JP A 63-69406, two main buses arranged in parallel and oppositely to each other and connected by a bus sectionalizing circuit are provided, and in the space formed between the two main buses, cable heads of power transmission lines and transformer circuits, auxiliary buses of the bus sectionalizing circuit, etc. are arranged. However, a circuit breaker of each circuit is arranged outside the bus sectionalizing circuit, and the space formed between the main buses is not considered.

On the other hand, in the underground under an electric station between a transformer and a gas-insulated switchgear equipped in the electric station, a cable channel accommodating cables electrically connecting the transformer and the gas-insulated switchgear is formed. The cable channel is one which is planed of root and practiced, based on an arrangement and construction of the gas-insulated switchgear installed in the electric station, and an electric company practices it. There may be a case where a construction of the cable channel becomes complicated and a load of the practice on the electric company side becomes large, depending on the arrangement and construction of the gas-insulated switchgear. Therefore, it is preferable to provide a gas-insulated switchgear which is able to simplify the construction of the cable channel.

Further, a conventional gas-insulated switchgear has a cable head arranged between two main buses, so that a cable channel can be constructed in a single way and the construction of the cable channel can be simplified. On the other hand, in the conventional gas-insulated switchgear, since a bus sectionalizing circuit is arranged on one end portion of the two main buses, in the case where bushings are arranged so as to oppose the end portion, a circuit for connecting the two main buses and the bushing is arranged on the side of the bus sectionalizing circuit opposite to the side of the bushing. Thereby, a connecting distance of a circuit connecting the two main buses and the bushing becomes large and the economy of the gas-insulated switchgear is lowered.

A representative object of the present invention is to provide a gas-insulated switchgear which can achieve both the simplification of a cable channel construction and the economy of the apparatus.

In order to achive the above-mentioned object, according to the present invention, a gas-insulated switchgear comprises first and second main buses arranged in parallel to each other, first and second cable leader circuits electrically connected to one of the first and second main buses, first and second bushing leader circuits electrically connected to the other of the first and second main buses, a bus sectionalizing circuit electrically connecting between the first and second main buses on the side of the first and second cable leader circuits closer than the first ans second bushing leader circuits, wherein at least one of the first and second bushing leader circuits has a circuit breaker unit arranged between the first and second main buses and interrupting electric power to the first and second main buses and a connecting unit arranged so as to interrupt one of the first and second main buses and introducing electric power to the circuit breaker unit.

A basic feature of the present invention is that bushing leader circuits are connected to lead-in steel tower side end portions of respective two main buses arranged approximately perpendicularly to a row of the lead-in steel towers and approximately in parallel with and oppositely to each other, and cable head units of cable leader circuits which are connected to two main buses, respectively are arranged in a space formed between the two main buses.

As for the cable head units, the cable head unit of the cable leader circuit connected to one of the main buses is arranged oppositely to the cable head unit of the cable leader circuit connected to the other main bus. Alternately, the cable head units are arranged in a row along the main buses.

Further, it also is possible to arrange a circuit breaker unit of a bus sectionalizing circuit for connecting the two main buses and circuit breaker units of bushing leader circuits in the space between the two buses. Further, in the case where the cable head units of the cable leader circuits are arranged in a row along the main buses, any one of the circuit breaker unit of the bushing leader circuit connected to one of the main buses and the circuit breaker unit of the bushing leader circuit connected to the other main bus is arranged in the space.

Furthermore, the cable leader unit is arranged on the opposite side to the lead-in steel towers with respect to the bus sectionalizing circuit.

### BRIEF DESCRIPTION OF THE DRAWINGS

FIG. 1 is a plan view showing an arrangement and construction of a gas-insulated switchgear of a first embodiment of the present invention;

FIG. 2 is a sectional view viewed in a direction of arrows II-II of FIG. 1, and showing a construction of a bus sectionalizing circuit;

FIG. 3 is a sectional view viewed in a direction of arrows III-III of FIG. 1, and showing a construction of bushing leader circuit;

FIG. 4 is a sectional view viewed in a direction of arrows IV-IV of FIG. 1, and showing a construction of cable leader circuit;

FIG. 5 is a single connection diagram showing a circuit of the gas-insulated switchgear of the first embodiment of the present invention;

FIG. 6 is a partial plan view showing an arrangement and construction of a gas-insulated switchgear of a second embodiment of the present invention;

FIG. 7 is a sectional view viewed in a direction of arrows VII-VII of FIG. 6, and showing a construction of a bus sectionalizing circuit;

FIG. 8 is a sectional view viewed in a direction of arrows VIII-VIII of FIG. 6, and showing a construction of bushing leader circuit;

FIG. 9 is a sectional view viewed in a direction of arrows IX-IX of FIG. 6, and showing a construction of cable leader circuit; and

FIG. 10 is a sectional view viewed in a direction of arrows X-X of FIG. 6, and showing a construction of cable leader circuit.

### DESCRIPTION OF EMBODIMENTS OF THE INVENTION

Embodiment 1

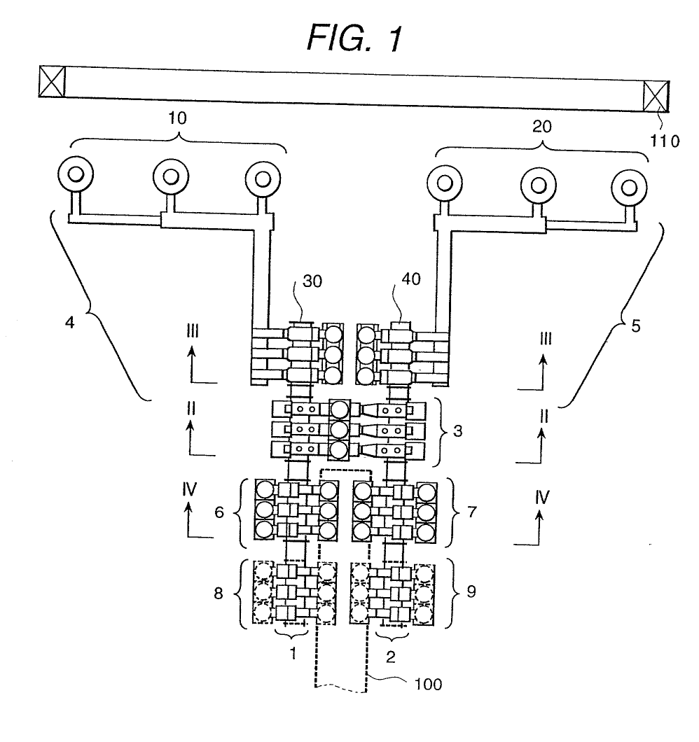

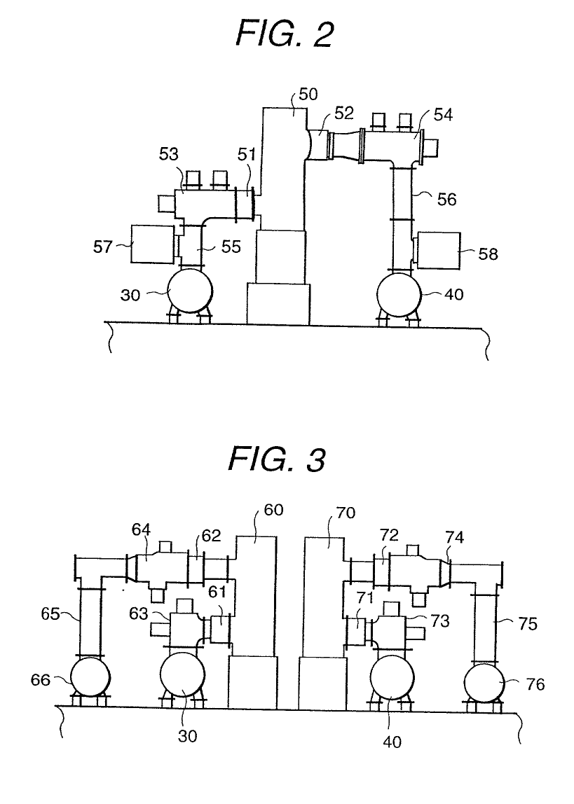

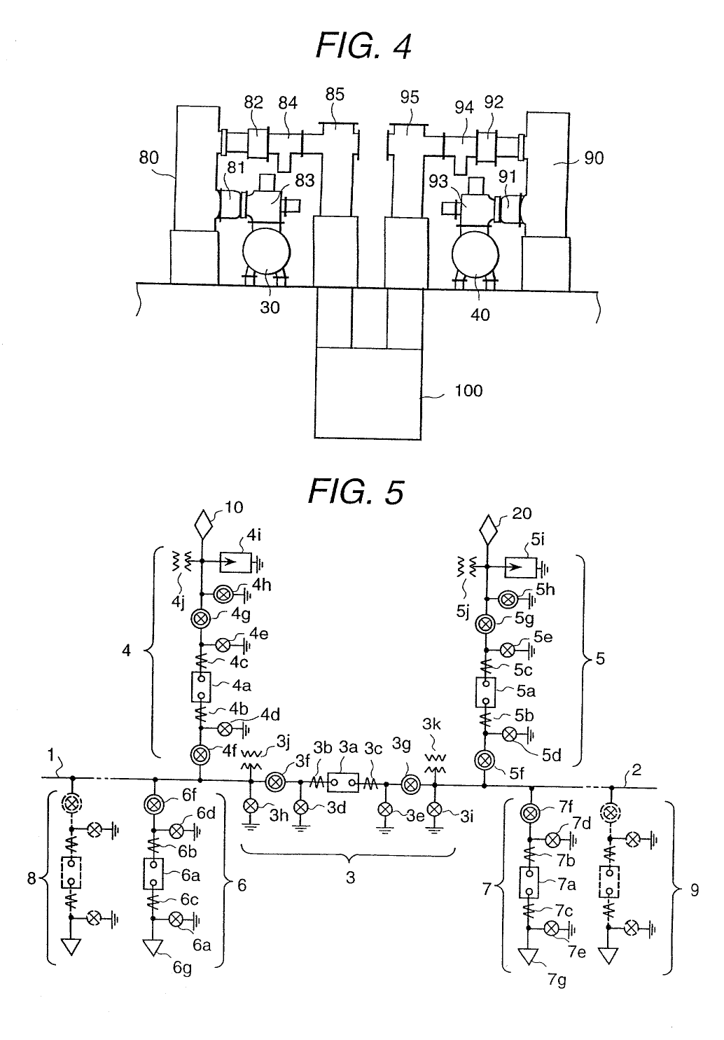

A first embodiment of the present invention is explained, referring to FIGS. 1 to 5. FIG. 5 shows a circuit construction ofh a gas-insulated switchgear of the present embodiment. In FIG. 1, reference numbers 1, 2 each denote a main bus, and the main buses 1, 2 are connected to each other through a bus sectionalizing circuit 3. The bus sectionalizing circuit 3 comprises a current transformer 3b, a grounding switch 3d, a disconnecting switch 3f, a grounding switch 3h and a transformer 3j each connected on the side of main bus 1, a current transformer 3c, a grounding switch 3e, a disconnecting switch 3g, a grounding switch 3i and a transformer 3k each connected on the side of main bus 2, and a circuit breaker 3a.

A bushing leader circuit 4 is connected between the main bus 1 and bushings 10, and a bushing leader circuit 5 is connected between the main bus 2 and bushings 11. The bushing leader circuit 4 comprises a current transformer 4b, a grounding switch 4d and a disconnecting switch 4f each connected on the side of the main bus 1, a wcurrent transformer 4c, a grounding switch 4d, a disconnecting switch 4g, a disconnecting switch 4h provided with a grounding device, an arrester 4i and a transformer 4j each connected on the side of the bushings 10, and a circuit breaker 4a. The bushing leader circuit 5 comprises a current transformer 5b, a grounding switch 5d and a disconnecting switch 5f each connected on the side of the main bus 2, a current transformer 5c, a grounding switch 5d, a disconnecting switch 5g, a disconnecting switch 5h having a grounding device, an arrester 5i and a transformer 5j each connected on the side of the bushings 20, and a circuit breaker 5a.

A cable leader circuit 6 is connected to the main bus 1, and a cable leader circuit 7 is connected to the main bus 2. The cable leader circuit 6 comprises a current transformer 6b, a grounding switch 6d and a disconnecting switch 6f each connected on the side of the main bus 1 from a circuit breaker 6a, a current transformer 6c, a grounding switch 6e and a cable head 6g each connected on the side opposite to the main bus 1, and the circuit breaker 6a. The cable leader circuit 7 comprises a current transformer 7b, a grounding switch 7d and a disconnecting switch 7f each connected on the side of the main bus 2 from a circuit breaker 7a, a current transformer 7c, a grounding switch 7e and a cable head 7g each connected on the side opposite to the main bus 2, and the circuit breaker 7a.

Reference numbers 8 and 9 (dotted line parts) each denote a cable leader circuit which may be added on in future, and each comprises a circuit breaker, a current transformer, a grounding switch, a disconnecting switch and a cable head in the same manner as the cable leader circuit 6, 7.

FIGS. 1 to 4 each show an apparatus construction of a real gas-insulated switchgear to which the circuit construction in FIG. 5 is applied. The main buses 1 and 2 are composed of bus units 30 and 40, respectively, and they are arranged in parallel and in opposition to each other and arranged perpendicularly to a row of leading-in steel towers 110. The bus units 30, 40 each are constructed so that bus conductors of three phases are accommodated in a lump in a tank hermetically containing therein SF₆ (sulfur hexafluoride) gas. The tank is a grounded container made of metal.

The bus sectionalizing circuit 3 connecting the main bus 1 and the main bus 2 is, in phase separation, composed of a circuit breaker unit 50, current transformer units 51, 52, switch units 53, 54, connecting bus units 55, 56 and transformer units, and arranged perpendicularly to the main buses 1, 2. Each unit is constructed so that construction apparatuses and conductors of the bus sectionalizing circuit 3 are contained in a tank containing therein SF₆ gas and the tank is a grounded container made of metal.

The circuit breaker unit 50 comprises the circuit breaker 3a and it is arranged in a space formed between the main bus 1 and the main bus 2. Further, the circuit breaker unit 50 can be arranged on side of the main bus 1 reverse to the side of the main bus 2 or on the side of the main bus 2 reverse to the side of the main bus 1. The current transformer unit 51 having the current unit 3b is connected to the circuit breaker unit 50 on the side of the main bus 1. The transformer unit 52 having the transformer 3c is connected to the circuit breaker unit 50 on the side of the main bus 2. Here, since the circuit breaker 3a is vertical type, the current transformer unit 51 is connected to a lower end side of the circuit breaker unit 50 and the current transformer unit 52 is connected to an upper end side of the circuit breaker unit 50. Further, the current transformer unit 51 can be connected to the upper end side and the current transformer unit 52 can be connected to the lower end side.

The switch unit 53, which is provided with the disconnecting switch 3f and the grounding switches 3d, 3h, is connected to the current transformer unit 51 on the opposite side to the side of the circuit breaker unit 50. The switch unit 54 having the disconnecting switch 3g and the grounding switches 3e, 3i is connected to the current transformer unit 52 on the opposite side to the side of the circuit breaker unit 50. The switch unit 53 is connected to the bus unit 30 through a connecting bus 55 provided with connecting buses, and the switch unit 54 is connected to the bus unit 40 through the connecting bus unit 56 having connecting buses. To the connecting bus unit 55 the transformer unit 57 having the transformer 3j is connected, and to the connecting bus unit 55 a transfer unit 58 having the transfer 3k is connected.

The bushing leader circuit 4 connecting the main bus 1 and the bushings 10 is composed of a circuit breaker unit 60, current transformer units 61, 62, switch units 63, 64, a connecting bus unit 65, a branch bus unit 66, an arrester unit not shown and a transformer unit not shown, and arranged at an end portion of the main bus 1 on the side of the leading-in steel towers 110. Each unit is constructed so that construction apparatuses and conductors of the bushing leader circuit 4 are contained in a tank containing therein SF₆ gas and the tank is a grounded container made of metal.

Parts composed of the circuit breaker unit 60, the current transformer units 61, 62, the switch units 63, 64 and the connecting bus unit 65 are formed in phase separation and arranged in a perpendicular direction to the main bus 1. The branch bus unit 66 is formed so that three phases are in a lump, extends in the same direction as the main bus 1, branches in each phase along a row of the bushings 10 in the vicinity of the bushings 10, and is connected to the bushings 10. The arrester unit not shown and the transformer unit not shown are connected to the bushing for each phase.

The circuit breaker unit 60 is provided with the circuit breaker 4a and is arranged in the space defined between the main bus 1 and the main bus 2 in opposition to the circuit breaker unit 70 of a bushing leader circuit 7 which is described later. Further, as for the circuit breaker unit 60, the current transformer unit 61 with the current transformer 4b and the current transformer unit 62 with the current transformer 4c are connected to the circuit breaker unit 60 on the side of the main bus 1. Here, since the circuit breaker 4a is vertical type, the current transformer unit 61 is connected to a lower end portion of the circuit breaker unit 60 and the current transformer unit 62 is connected to an upper end portion of the circuit breaker unit 60.

The switch unit 63 with the disconnecting switch 4f and the grounding switch 4d is connected to the current transformer unit 61 on the side thereof opposite to the side of the circuit breaker 60. The switch unit 64, which is provided with the disconnecting switch 4g, the grounding switch 4e and the disconnecting switch 4h with the grounding device, is connected to the current transformer unit 62 on the side thereof opposite to the side of the circuit breaker unit 60. The switch unit 63 is connected to the bus unit 30. The switch unit 64 is connected to the branch bus unit 66 through the connecting unit 65 with connecting buses.

The bushing leader circuit 5 connecting the main bus 2 and the bushings 20 is composed of a circuit breaker unit 70, current transformer units 71, 72, switch units 73, 74, a connecting bus unit 75, a branch bus unit 76, an arrester unit not shown and a transformer unit not shown, and arranged at an end portion of the main bus 2 on the side of the leading-in steel towers 110 so as to oppose the bushing leader circuit 4. Each unit is constructed so that construction apparatuses and conductors of the bushing leader circuit 5 are contained in a tank containing therein SF₆ gas. The tank is a grounded container made of metal.

Parts composed of the circuit breaker unit 70, the current transformer units 71, 72, the switch units 73, 74 and the connecting bus unit 75 are formed in phase separation and arranged in a perpendicular direction to the main bus 2. The branch bus unit 76 is formed so that three phases are in a lump, extends in the same direction as the main bus 2, branches in each phase along a row of the bushings 20 in the vicinity of the bushings 20, and is connected to the bushings 20. The arrester unit not shown and the transformer unit not shown are connected to the bushing 20 for each phase.

The circuit breaker unit 70 is provided with the circuit breaker 5a and is arranged in the space defined between the main bus 1 and the main bus 2 in opposition to the circuit breaker unit 60 of the bushing leader circuit 6 which is described previously. The current transformer unit 71 with the current transformer 5b and the current transformer unit 72 with the current transformer 5c are connected to the circuit breaker unit 70 on the side of the main bus 2. Here, since the circuit breaker 5a is a vertical type, the current transformer unit 71 is connected to a lower end portion of the circuit breaker unit 70 and the current transformer unit 72 is connected to an upper end portion of the circuit breaker unit 70.

The switch unit 73 with the disconnecting switch 5f and the grounding switch 5d is connected to the current transformer unit 71 on the side thereof opposite to the side of the circuit breaker 70. The switch unit 74, which is provided with the disconnecting switch 5g, the grounding switch 5e and the disconnecting switch 5h with the grounding device, is connected to the current transformer unit 72 on the side thereof opposite to the side of the circuit breaker unit 70. The switch unit 73 is connected to the bus unit 40. The switch unit 74 is connected to the branch bus unit 76 through the connecting unit 75 with connecting buses.

Further, in the present embodiment, the case where the circuit breaker units 60, 70 are arranged in the space formed between the main bus 1 and the main bus 2 has been explained, however, it also is possible to arrange the circuit breaker 60 on the side of the main bus 1 opposite to the side of the main bus 2 and arrange the circuit breaker 70 on the side of the main bus 2 opposite to the side of the main bus 1. Further, it is possible to arrange either one of the circuit breakers 60 and 70 in the space formed between the main bus 1 and the main bus 2.

The cable leader circuit 6 connected to the main bus 1 is, in phase separation, composed of a circuit breaker unit 80, current transformer units 81, 82, switch units 83, 84 and a cable head unit 85, arranged in a perpendicular direction to the main bus 1, and connected to the main bus 1 on the opposite side of the main bus sectionalizing circuit 3 of the main bus 1 to the side of the leading-in steel towers 110. Each unit is constructed so that construction apparatuses and conductors of the cable leader circuit 6 are contained in a tank containing therein SF₆ gas. The tank is a grounded container made of metal.

The circuit breaker unit 80 is provided with the circuit breaker 6a, and arranged on the main bus 1 side opposite to the main bus 2 side. A current transformer unit 81 with the current transformer 6b and a current transformer unit 82 with the current transformer 6c are connected to the circuit breaker unit 80 on the side of main bus 1. Here, since the circuit breaker 6a is a vertical type, the current transformer unit 81 is connected to a lower end portion of the circuit breaker unit 80 and the current transformer unit 82 is connected to an upper end portion of the circuit breaker unit 80.

The switch unit 83, which is provided with the disconnecting switch 6f and the grounding switch 6d, is connected to the current transformer unit 81 on the side opposite to the side of the circuit breaker 80, and the switch unit 84 with the grounding switch 6e is connected to the current transformer unit 82 on the side opposite to the side of the circuit breaker unit 80. The switch unit 83 is connected to the bus unit 30. A cable head unit 85 with the cable head 6g is connected to the switch unit 84.

The cable head unit 85 is arranged in the space formed between the main bus 1 and the main bus 2 so as to oppose a cable head unit 95 of the cable leader circuit 7 as described later. A cable tunnel 100 is formed in an underground portion under the cable head unit 85. The cable tunnel 100 extends to an install position of a transformer not shown, and a cable electrically connecting the transformer and the gas-insulated switchgear is accommodated therein. The cable is connected to the cable head 6g of the cable head unit 85.

The cable leader circuit 7 connected to the main bus 2 is, in phase separation, composed of a circuit breaker unit 90, current transformer units 91, 92, switch units 93, 94 and a cable head unit 95, arranged in a perpendicular direction to the main bus 2, and connected to the main bus 2 at a position opposite to the cable leading-in circuit 6. Each unit is constructed so that construction apparatuses and conductors of the cable leader circuit 7 are contained in a tank containing therein a SF₆ gas. The tank is a grounded container made of metal.

The circuit breaker unit 90 is provided with the circuit breaker 7a, and is arranged on the side of the main bus 2 opposite to the main bus 1 side. A current transformer unit 91 having the current transformer 7b and a current transformer unit 92 having the current transformer 7c are connected to the circuit breaker unit 90 on the side of main bus 2. Here, since the circuit breaker 7a is a vertical type, the current transformer unit 91 is connected to a lower end portion of the circuit breaker unit 90 and the current transformer unit 92 is connected to an upper end portion of the circuit breaker unit 90.

The switch unit 93 having the disconnecting switch 7f and the grounding switch 7d is connected to the current transformer unit 91 on the side opposite to the side of the circuit breaker 90, and the switch unit 94 having the grounding switch 7e is connected to the current transformer unit 92 on the side opposite to the side of the circuit breaker unit 90. The switch unit 93 is connected to the bus unit 40. The cable head unit 95 having the cable head 7g is connected to the switch unit 94.

A cable head unit 95 is arranged in the space formed between the main bus 1 and the main bus 2 so as to oppose the cable head unit 85 of the cable leader circuit 6 as described later. The cable tunnel 100 is formed in an underground portion under the cable head unit 95. The cable tunnel 100 extends to an install position of a transformer not shown, and a cable electrically connecting the transformer and the gas-insulated switchgear is accommodated therein. The cable is connected to the cable head 7g of the cable head unit 95.

Further, reference numbers 8, 9 denote cable leader circuits 8, 9 which will be added on in future, and which are constructed the same as the above-mentioned cable leading-in circuits 6, 7 and connected to the main buses 1, 2, respectively.

According to the present embodiment, since the cable head unit 85 of the cable leading-in circuit 6 and the cable head unit 95 of the cable leading-in circuit 7 a re arranged in the space formed between the main bus 1 and the main bus 2, the cable channel 100 formed in the underground portion under the cable head units 85 and 95 can be composed of only one channel, whereby the construction of the cable channel 100 can be simplified. Therefore, it is easy to plan a root of the cable channel 100 and a load of its practice on an electric power company side can be reduced.

Further, according to the present embodiment, since the bushing leader circuit 4 is connected to an end portion of the main bus 1 on the side of the leading-in steel tower 110 and the bushing leader circuit 5 is connected to an end portion of the main bus 2 on the side of the leading-in steel tower 110, the length of branch bus of the bushing leader circuits 4, 5 can be minimized. Therefore, the cost of the gas-insulated switchgear can be reduced and the economy thereof can be improved.

Further, according to the present embodiment, since the circuit breaker unit 50 of the bus sectionalizing circuit 3 is arranged in the space formed between the main bus 1 and the main bus 2, the length of the connecting bus forming the bus sectionalizing circuit 3 can be shortened as compared with the case where the circuit breaker unit 50 is arranged on the side of the main bus 1 opposite to the side of the main bus 2, or on the side of the main bus 2 opposite to the side of the main bus 1. Therefore, the cost of the gas-insulated switchgear can be reduced and the economy thereof can be improved.

Further, according to the present embodiment, since the circuit breaker units 60, 70 of the bushing leader circuits 4, 5 are arranged in the space formed between the main bus 1 and the main bus 2, the length of connecting buses forming the bushing leader circuits 4, 5 can be shortened. Therefore, a cost of the gas-insulated switchgear can be reduced and the economy can be improved.

Further, according to the present embodiment, since the cable leader line 6 is connected on the side opposite to the side of the leading-in steel tower 110 with respect to the bus sectionalizing circuit 3 of the main bus 1, and the cable leader circuit 7 is connected on the side opposite to the side leading-in steel tower 110 with respect to the bus sectionalizing circuit 3 of the main bus 2, in the case where a cable leader circuit will be added on in future, such circuit addition that a bus unit and cable leader circuit will be increased on the side opposite to the side of the leading-in steel tower 110 of the main buses 1, 2 can be achieved without disassembling the other circuits. Therefore, the workability when cable leader circuits will be added on can be improved.

Embodiment 2

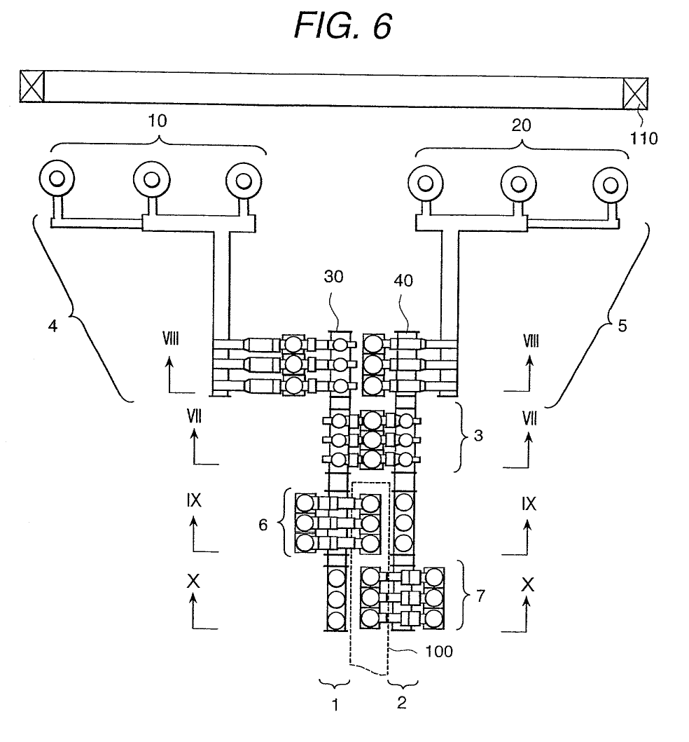

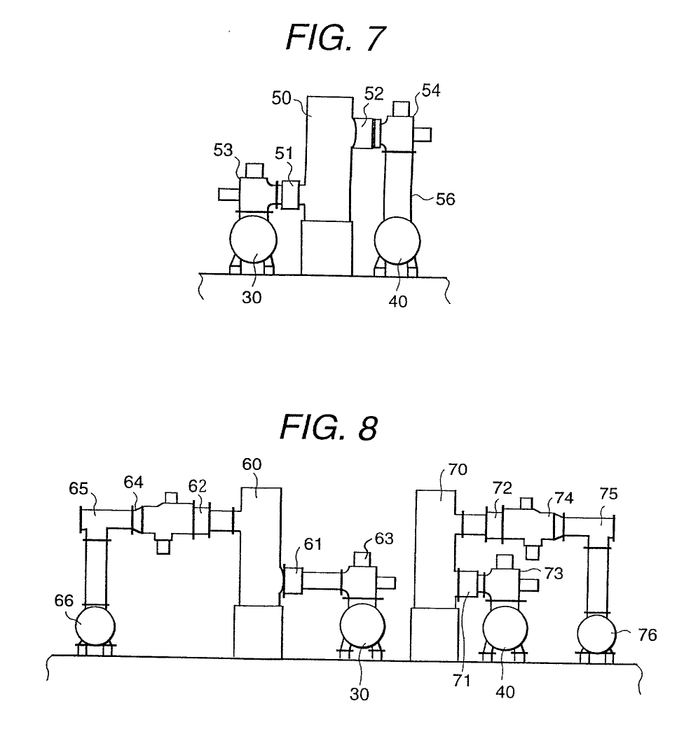

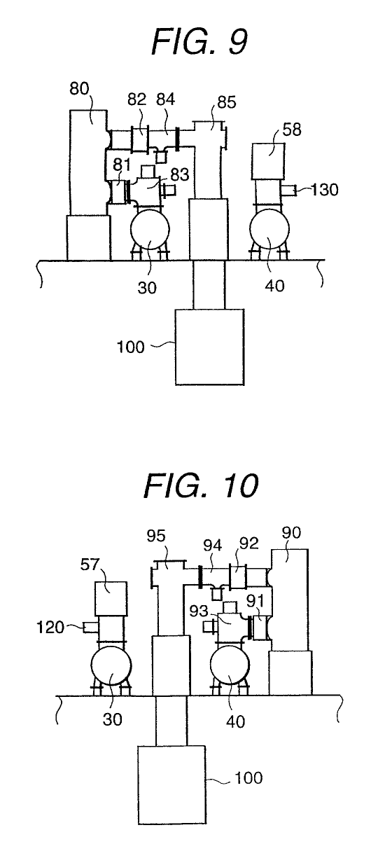

A second embodiment of the present invention is explained, referring to FIGS. 6 to 10. A gas-insulated switchgear of the present embodiment is an improvement of the first embodiment, in which a distance between the main bus 1 and the main bus 2 is made small, the cable leader circuits 4 and 5 which are arranged in an opposite relation are changed to be arranged alternately along the main buses 1, 2 in order to further simplify the cable channel 100. Therefore, the cable head unit 85 of the cable leader circuit 4 and the cable head unit 95 of the cable leader circuit 5 are arranged in a row along the main buses 1, 2 in the space formed between the main bus 1 and the main bus 2.

Further, in future, in the case where the cable leader circuits 8, 9 are added on and a plurality of cable leader circuits are connected on the side opposite to the side of the leading-in steel tower 110 with respect to the bus sectionalizing circuit 3 of the main buses 1, 2, the cable head unit of the cable leader circuit connected to the main bus 1 and the cable head unit of the cable leader circuit connected to the main bus 2 are arranged alternately along the main buses 1, 2. Therefore, the cable head units are arranged in a row along the main buses 1, 2 in the space formed between the main bus 1 and the main bus 2.

Further, in the present embodiment, the distance between the main bus 1 and the main bus 2 becomes narrow and it is impossible to arrange the circuit breaker unit 60 of the bushing leader circuit 4 and the circuit breaker unit 70 of the bushing leader circuit 60 in an opposite relation in the space formed between the main buses 1 and 2, whereby the circuit breaker unit 60 of the bushing leader circuit 4 is arranged on the side of the main bus 1 opposite to the side of main bus 2, and the circuit breaker unit 70 of the bushing leader circuit 5 is arranged in the space formed between the main bus 1 and the main bus 2. It is possible to arrange the circuit breaker unit 60 in the space formed between the main bus 1 and the main bus 2 and arrange the circuit breaker unit 70 on the side of the main bus 2 opposite to the side of the main bus 1.

Further, in the present embodiment, since an installation space is formed at a portion of the main bus 2 opposite to the cable leader circuit 4 and at a portion of the main bus 1 opposite to the cable leader circuit 5, the grounding switch 3i is separated from the switch unit 54 of the bus sectionalizing circuit 3, newly arranged, as a switch unit 130, in a portion of the main bus 2 opposite to the cable leader circuit 4 and connected to the bus unit 40. A transformer unit 58 is connected to the switch unit 130. Further, the grounding switch 3h is separated from the switch unit 53 of the bus sectionalizing circuit 3, newly arranged, as a switch unit 120, in a portion of the main bus 1 opposite to the cable leader circuit 5 and connected to the main bus unit 30. A transformer unit 57 is connected to the switch unit 120.

The other constructions are the same as the previous embodiment, so that explanation thereof will be omitted.

According to the present embodiment, since the cable head unit 85 of the cable leader circuit 6 and the cable head unit 95 of the cable leader circuit 7 are arranged in a row along the main buses 1, 2, the distance between the main bus 1 and the main bus 2 can be made narrower than the previous example, and the construction of the cable channel 100 can be simplified further. Therefore, a load in practice on the electric power company side can be further reduced.

Industrial Applicability

According to the present invention, since the cable head units of the cable leader circuits connected to the two main buses, respectively are arranged in the space formed between the two main buses, the cable channel formed in the underground under the cable head units can be composed of only one channel, whereby the construction of the cable channel can be simplified. Further, since the bushing leader circuit is connected on the end portion of the two main buses on the side the leading-in steel tower, a connecting distance of the bushing connecting leader circuit connecting the two main buses and the bushings becomes short. Therefore, a gas-insulated switchgear which can achieve both the simplification of construction of the cable channel and the economy of the apparatus can be provided.

What is claimed is

1. A gas-insulated switchgear comprising
at least two main buses arranged in parallel and oppositely to each other and approximately perpendicularly to a row of leading-in steel towers;
bushing leader circuits connected to end portions of said two main buses, respectively, on the side of said leading-in steel towers;
cable leader circuits connected to said two main buses, respectively; and
a bus sectionalizing circuit connecting between said two main buses, characterized in that
said cable leader circuits each have a unit provided with a cable head, and said cable head units are arranged in a space formed between said two main buses.

2. A gas-insulated switchgear comprising
at least two main buses arranged in parallel and oppositely to each other and approximately perpendicularly to a row of leading-in steel towers;
bushing leader circuits connected to end portions of said two main buses, respectively, on the side of said leading-in steel towers;
cable leader circuits connected to said two main buses, respectively; and
a bus sectionalizing circuit connecting between said two main buses, characterized in that
said cable leader circuits have units each provided with a cable head, and said cable head units are arranged oppositely to each other in a space formed between said two main buses.

3. A gas-insulated switchgear comprising
at least two main buses arranged in parallel and oppositely to each other and approximately perpendicularly to a row of leading-in steel towers;
bushing leader circuits connected to end portions of said two main buses, respectively, on the side of said leading-in steel towers;
cable leader circuits connected to said two main buses, respectively; and
a bus sectionalizing circuit connecting between said two main buses, characterized in that
said cable leader circuits have units each provided with a cable head, and said cable head units are arranged in a space formed between said two main buses and in a row along said two main buses.

4. A gas-insulated switchgear according to claim 3, characterized in that said cable leader circuits are arranged on the opposite side to the side of said leading-in steel towers with respect to said bus sectionalizing circuit.

5. A gas-insulated switchgear according to claim 3, characterized in that said bus sectionalizing circuit has a unit provided with a circuit breaker, and said circuit breaker unit is arranged in the space formed between said two main buses.

6. A gas-insulated switchgear according to claim 2, characterized in that said bushing leader circuits have units each provided with a circuit breaker, and said circuit breaker units are arranged in the space formed between said two main buses.

7. A gas-insulated switchgear according to claim 3, characterized in that said bushing leader circuits have units each provided with a circuit breaker, and any one of said circuit breaker units is arranged in the space formed between said two main buses.

8. A gas-insulated switchgear according to claim 3, characterized in that said cable leader circuits are arranged on the opposite side to the side of said leading-in steel towers with respect to said bus sectionalizing circuit.

9. A gas-insulated switchgear comprising
first and second main buses arranged in parallel to each other;
first and second cable leader circuits electrically connected to one of said first and second main buses,
first and second bushing leader circuits electrically connected to the other of said first and second main buses;
a bus sectionalizing circuit electrically connecting between said first and second main buses on the side of said first and second cable leader circuits closer than said first and second bushing leader circuits; and
wherein at least one of said first and second bushing leader circuits has a circuit breaker unit arranged between said first and second main buses and interrupting electric power to said first and second main buses and a connecting unit arranged so as to interrupt one of said first and second main buses and introducing electric power to said circuit breaker unit.

10. A gas-insulated switchgear according to claim 9, characterized in that there is proided a branch bus unit arranged in parallel to said first and second main buses, said branch bus unit is arranged out of said first and second main buses, said connecting unit electrically connects said branch unit and said first and second main buses, and intersects to said first and second main buses at an approximately right angle.

11. A gas-insulated switchgear according to claim 10, characterized in that there is provided a bushing, electric power from said bushing is led to said first and second main buses through said branch bus unit.

12. A gas-insulated switchgear according to claim 11, characterized in that said circuit breaker unit and said first ans second main buses are connected each other through a first current transformer unit or a first switch unit, said circuit breaker unit and said branch bus unit are connected each other through a second current transformer unit or a second switch unit, and said second current transformer unit or said second switch unit is arranged above said first current transformer unit or said first switch unit.

13. A gas-insulated switchgear according to claim 9, characterized in that said cable leader circuit has a unit provided with a cable head, and said cable head unit is arranged in a space formed between said first and second main buses.
